(19) United States
(12) Patent Application Publication
(10) Pub. No.: US 2018/0312733 A1
(43) Pub. Date: Nov. 1, 2018

(54) COMPOSITION FOR THE PREPARATION OF AN ADHESIVE PRODUCT

(71) Applicant: GLOO S.R.L.S., Cittadella (IT)

(72) Inventors: Ruggero RICCI MINGANI, Bernareggio (IT); Enzo MASETTO, Treviso (IT)

(21) Appl. No.: 15/774,089

(22) PCT Filed: Nov. 10, 2016
(86) PCT No.: PCT/IB2016/056765

§ 371 Date: May 7, 2018

(30) Foreign Application Priority Data
Nov. 11, 2015 (IT) 102015000071582

(51) Int. Cl. C09J 123/14; C09J 123/08; C09J 9/00; B29C 39/00; B29C 39/38

(52) U.S. Cl. CPC C09J 123/142; C09J 123/0807; B29K 2105/0097; B29C 39/003; B29C 39/38; C09J 9/005

(57) ABSTRACT

The invention relates to an adhesive composition comprising: —at least one hydrocarbon resin in an amount of at most 40% by weight with respect to the total weight of the composition; —at least one polyolefin derived from the polymerization of ethylene and/or propylene with metallocene catalysis having a density in the range from 0.8 to 0.9 g/cm³, and; —ethylene vinyl acetate (EVA) copolymer in an amount of at most 15% by weight with respect to the weight of the composition. Such adhesive composition allows preparing a ready-to-use adhesive product, applicable by rubbing and which does not require packaging during use.

### FIELD OF THE INVENTION

The invention relates to an adhesive composition for use in the preparation of an adhesive product, preferably suitable for use in stationery.

### PRIOR ART

The adhesive products currently on the market differ according to the application system.

Liquid adhesive products have been made, such as for example liquid glue known under the trade name of “Pritt fluid”, “VINAVIL” or “UHU pen”, or paste such as “Pritt stick”, which are applied and coupled with the humid product and bonding takes place by drying.

In U.S. Pat. No. 5,703,153 an adhesive composition comprising ethylene vinyl acetate copolymer, and two adhesive resins is described, wherein the copolymer is in an amount of 60% by weight. The application is carried out by means of guns working at high temperatures.

In US 2012/03153 a solid high-strength adhesive formulation is described. This formulation includes polyvinylpyrrolidone and at least one polymeric dispersion comprising polyurethane and which is able to withstand high temperatures.

The object of the present invention therefore is to provide an adhesive product that does not exhibit tackiness before use and which allows the development of the adhesive effect exclusively due to friction with a paper support or another support adapted to be glued or to act as support.

Surprisingly, a new product has been discovered which does not need packaging during application and which simultaneously allows the application of an adhesive product on a support by rubbing on the same support on which the adhesive is to be applied.

### SUMMARY

The above object is achieved by means of an adhesive composition comprising:
at least one hydrocarbon resin in amount of at most 40% by weight with respect to the total weight of the composition;
at least one polyolefin derived from the polymerization of ethylene and/or propylene through metallocene catalysis and having a density in the range from 0.8 to 0.9 g/cm³; and
ethylene vinyl acetate (EVA) copolymer in a maximum amount equal to 15% by weight with respect to the total weight of the composition.

In the present invention, when the following terms are used:
“hydrocarbon resin preferably having a predetermined softening point”, it is intended a resin wherein the softening point was determined by the method specified by the manufacturer on the respective technical data sheet, generally according to the ASTM E28 method (ring & ball) or, alternatively, according to the ETM E-24 method (ExxonMobil Test Method based on ASTM D-6090-97)
“a polyolefin derived from the polymerization of ethylene and/or propylene with metallocene catalysis having a predetermined density”, it is intended a polyolefin wherein the density was determined by the method specified by the manufacturer on the technical data sheet.

The invention also relates to a glue product comprising and obtainable from the adhesive composition of the invention and excipients suitable for use.

The inventors of the present invention have surprisingly prepared a glue product that is ready for use and is advantageously made and used as an adhesive product without the use of any type of packaging, except what is strictly necessary to the presentation of the product.

The inventors have in fact surprisingly found the combination of the three ingredients above that allows increasing the transfer of material from the adhesive to the support and, at the same time, ensures the sliding, i.e. the ability to apply the product with a reduced pressure and a reduced tangential force, so that the use is simple even for children.

A product has thus surprisingly been obtained, having a good adhesiveness, a sufficient transfer on the support and at the same time having a consistency such as not to produce filaments and smears during application. Without being bound to any theory, the inventors believe that they have succeeded by studying the incompatibility between certain raw materials, by type and quantity which, while allowing a “clean” distribution, do not interfere with the adhesiveness of the product.

Advantageously, therefore, the glue product of the invention is neither easily deformed as is the case for paste products, to prevent it from being accidentally damaged during use, nor is in liquid form to prevent accidental leakage thereof.

The material may be realized in different shapes and colors, as well as in different fragrances.

As will be apparent from the following detailed description and experimental part, the product is able to glue paper on paper in a permanent manner, but also to glue paper on non-absorbent supports in a semi-permanent manner of the “stick & remove” type without dirtying the surfaces.

### DESCRIPTION OF THE FIGURES

FIG. 1 corresponds to the IR spectrum of the product of the invention obtained in example 1.

### DETAILED DESCRIPTION OF THE INVENTION

The invention therefore relates to an adhesive composition comprising:
at least one hydrocarbon resin in amount of at most 40% by weight with respect to the total weight of the composition;
at least one polyolefin derived from the polymerization of ethylene and/or propylene through metallocene catalysis and having a density in the range from 0.8 to 0.9 g/cm³;
ethylene vinyl acetate (EVA) copolymer in an amount of at most 15% by weight with respect to the total weight of the composition.

The adhesive composition of the invention therefore comprises one or more hydrocarbon resins, in a maximum amount of 40% by weight with respect to the total weight of the composition. Preferably, said one or more hydrocarbon resin is preferably hydrogenated and is, more preferably, transparent colorless, i.e. generally indicated by the term “water white”. “Water white” resins were found to be preferable over resins not hydrogenated or hydrogenated but not white water, as they are completely transparent, colorless and odorless, thus advantageously allowing a final product to be obtained which is devoid of yellow color and undesired odor. Still more preferably, said one or more hydrocarbon resin has a softening point in the range from 80 to 130° C. Said one or more hydrocarbon resins are preferably in amount of at most 35% by weight with respect to the total weight of the adhesive composition.

In a preferred embodiment of the invention, the composition comprises at least one hydrocarbon resin, preferably hydrogenated, more preferably “water white”, having a softening point in the range from 120 to 130° C. Advantageously, in this embodiment said resin is in an amount of at least 5% by weight with respect to the total weight of the adhesive composition. Up to at most 35%, or preferably 30%, the remaining amount of hydrogenated hydrocarbon resin may be a resin having a softening point in the range from 85 to 100° C.

Preferably, said hydrocarbon resin is hydrogenated and is a resin selected from the group consisting of: hydrogenated hydrocarbon resin sold under the trade name of REGALITE R1090 by Eastman, hydrogenated hydrocarbon resin sold under the trade name of ARKON P125 by Arakawa, hydrogenated hydrocarbon resin sold under the trade name of Eastotac H-130W (hydrogenated C5) by Eastman, hydrogenated hydrocarbon resin sold under the trade name of Escorez 5320 by Exxon, hydrogenated hydrocarbon resin sold under the trade name of Regalite R1125 (hydrogenated C9) by Eastman.

In one embodiment of the invention, the composition contains a different proportion between the two types of resins having different softening points. By increasing the proportion of hydrocarbon resin, preferably hydrogenated and white water and having a softening point in the range from 120 to 130° C., at the expense of the hydrogenated hydrocarbon resin, preferably white water and having a softening point in the range from 80 to 130° C., alternative versions of the preferred composition may be obtained, having increasing shore hardness.

The adhesive composition also comprises at least one polyolefin derived from the polymerization of ethylene and/or propylene through metallocene catalysis and having a density in the range from 0.8 to 0.9 g/cm³, preferably a density in the range from 0.86 to 0.89 g/cm³

Preferably, said polyolefin derived from the polymerization of ethylene/propylene with metallocene catalysis is one selected from the group consisting of: polyolefin derived from the polymerization of ethylene and/or propylene with metallocene catalysis sold under the trade name of LICOCENE PP1302 sold by Clariant, polyolefin derived from the polymerization of ethylene and/or propylene with metallocene catalysis sold under the name of LICOCENE PP1502 by Clariant, polyolefin derived from the polymerization of ethylene and/or propylene with metallocene catalysis sold under the name of LICOCENE PP1602 by Clariant, polyolefin derived from the polymerization of ethylene and/or propylene with metallocene catalysis sold under the name of LICOCENE PP2602 sold by Clariant, polyolefin derived from the polymerization of ethylene and/or propylene with metallocene catalysis sold under the name of Affinity GA1900 or Affinity GA1950, both manufactured by Dow.

The adhesive composition also comprises an ethylene vinyl acetate copolymer. Said EVA copolymer is in an amount of at most 15% by weight with respect to the weight of the composition, preferably in amounts from 10 to 15% by weight with respect to the weight of the total composition. Preferably, said ethylene vinyl acetate copolymer is a copolymer selected from the group consisting of ethylene vinyl acetate copolymer sold under the trade name of Escorene Ultra MV 02528EH2 (sold by Exxon), ethylene vinyl acetate copolymer sold under the trade name of Evatane 50018, ethylene vinyl acetate copolymer sold under the trade name of EVA Alcudia PA-448, Evatane 15028, Evatane 15018 (all sold by Arkema), ethylene vinyl acetate copolymer sold under the trade name of LG EVA 15028 (by LG Chem), ethylene vinyl acetate copolymer sold under the trade name of Seetec VA900 (by Lotte Chemicals).

Alternatively, the ethylene vinyl acetate copolymer of the invention may be a product based on EVA grafted with maleic anhydride, such as the product known under the trade name of Orevac 9305 sold by Arkema.

The composition also comprises excipients selected from the group consisting of dyes, pigments, perfumes, glitter.

In another aspect thereof, the invention comprises a glue product comprising the adhesive composition according to the invention and excipients suitable for the final formulation.

The glue product is therefore prepared with the adhesive composition of the invention.

Therefore, the invention also relates to a process for the preparation of a glue product comprising the steps of:
a) placing the adhesive composition described above in a suitable container;
b) heating and mixing the composition at a temperature in the range from 125° C. to 220° C.;
c) pouring the product of step b) in a suitable mould of desired shape; and
d) cooling the product in the mould of step c) to a temperature from −10° C. to 25° C.

In the process of the invention, the suitable container of step a) is a container preferably having non-stick surfaces.

In step b), the heating temperature of the mixture is preferably about 200° C. The heating preferably takes place on an electric plate. The mixing may advantageously be carried out during heating, either in a continuous manner or for repeated short periods of time.

Between step b) and step c), advantageously the product of step b) is subjected to a degassing step, preferably under vacuum.

In step c), the suitable mould of desired shape is made of silicone material or other non-stick surface.

In step d), the product of step c) is cooled to a temperature in the range from −10° C. to 25° C., preferably through water (also with antifreezing liquid), optionally also in the presence of a detaching additive, or through air with temperatures from −10° C. to 25° C. or still through nitrogen or other cryogenic gas.

Advantageously, the product of the process is left to rest for at least one hour before removing it from the mould and obtain the product of the invention in the desired shape.

In another aspect thereof, the invention therefore relates to a ready-to-use glue product obtainable by the process indicated above.

The final product thus obtained advantageously has no packaging and is prepared in a desired shape determined by the mould of step c). This product is a glue product that can be applied by simple rubbing on a support. Advantageously, the product of the invention is suitable for home use, as stationery item. It has no packaging, but can be handled without problems of product release on the hands, because it is not sticky or deformable to the touch. It can be advantageously applied on a support, such as paper, by simple rubbing and, where applied, it exhibits good adhesive properties, allowing the adhesion of a second support such as paper, glass, plastic, metal, wood, ceramic, plaster, painted substrates.

The invention therefore relates to the use of the adhesive product of the invention as a ready-to-use stationery adhesive free of packaging during use.

### EXPERIMENTAL PART

### Example 1: Preparation of Product 1 of the Invention

The following ingredients in the indicated amounts were placed in a container with non-stick surfaces:

30 grams of white water hydrogenated hydrocarbon resin sold under the trade name of Regalite R1090 by Eastman and having a softening point of 88° C. (as determined by the ASTM E-28 (ring and ball) method as indicated by the manufacturer on the technical data sheet)

5 grams of white water hydrogenated hydrocarbon resin sold under the trade name of Regalite R1125 by Eastman and having a softening point of 125° C. (as determined by the ASTM E-28 (ring and ball) method as indicated by the manufacturer on the technical data sheet)

55 grams of polyolefin derived from the polymerization of ethylene and propylene through metallocene catalysis sold under the trade name of Licocene PP1502 by Clariant and having a density of 0.87 g/cm³

10 grams of ethylene vinyl acetate copolymer sold under the trade name of Escorene Ultra MV02528 EH2 by Exxon. Said EVA had an elongation at break of about 140% and a tensile strength of 1.5 MPa (as determined by the ISO527-ASTM D638 method, respectively, as indicated by the manufacturer on the technical data sheet).

The ingredients, in form of granules or crystals, were placed in a container with non-stick surfaces and heated on a laboratory electric plate set at a temperature of 200° C. The product was mixed, every three minutes, with a Teflon rod. After about 12 minutes, the material appeared totally melted and evenly mixed. The container was then placed in an oven, preheated to 180° C., for ten minutes, to allow the expulsion of incorporated air from the mixture (degassing).

The resulting product was then poured into silicone formwork and it was cooled with water. The cooled product was then left to rest for about three hours and then taken out of the moulds.

The glue product thus obtained was not deformable or sticky to the touch.

The softening point of the resulting product 1 was evaluated by the ASTM E28 (Ring & Ball) and TMA methods (Thermomechanical Analysis, internal method Unicol with Seiko Exstar TMA/SS6000 instrument).

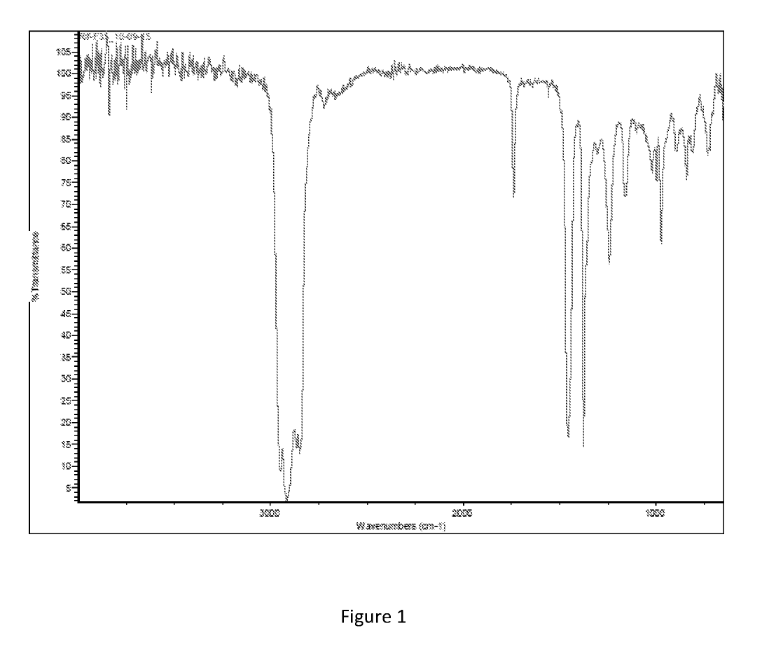

The softening point was 71° C. and the TMA was 64.7° C. The IR spectrum of the product was then obtained (internal method Unicol with Nicolet Nexus FT-IR instrument) and the spectrum shown in FIG. 1 was obtained.

The glue product was tested for the following properties:
SLIDING: on a sheet of A4 paper, the glue product of the invention was applied by rubbing so as to leave an adhesive strip of 3-4 mm in width, the sliding was assessed on a scale of 1 to 4, where 1 is insufficient, 2 is sufficient, 3 is good and 4 is excellent;
TRANSFER ON PAPER: on a sheet of A4 paper, the glue product of the invention was applied by rubbing so as to leave an adhesive strip of 3-4 mm in width, and the transfer on paper was assessed on a scale of 1 to 4, where 1 is insufficient, 2 is sufficient, 3 is good and 4 is excellent;
FILM TACKINESS: on a sheet of A4 paper, the glue product of the invention was applied by rubbing so as to leave an adhesive strip of 3-4 mm in width and the tackiness was assessed on a scale of 1 to 4, where 1 is insufficient, 2 is sufficient, 3 is good and 4 is excellent;
ADHESION: on a sheet of A4 paper, the glue product of the invention was applied by rubbing so as to leave an adhesive strip of 3-4 mm in width between 5 mm and 25 mm from the edge, for about 80% of the sheet width, then the two heads of the sheet were coupled and the thumb was passed 3 times applying a pressure at the adhesive. The adhesion was assessed on a scale of 1 to 4, where 1 is insufficient, 2 is sufficient, 3 is good and 4 is excellent.
PAPER TEARING: on a sheet of A4 paper, the glue product of the invention was applied by rubbing so as to leave an adhesive strip of 3-4 mm in width between 5 mm and 25 mm from the edge, for about 80% of the sheet width, and a second paper strip similar to the first one, at a distance of about two cm. The sheet was then folded so as to superimpose the two strips of glue and the thumb was passed 3 times applying pressure at the adhesive. The paper tearing was assessed on a scale of 1 to 4, where 1 is insufficient, 2 is sufficient, 3 is good and 4 is excellent.

The following results were obtained:

| TEST | |
|---|---|
| sliding | 3 |
| transfer on paper | 4 |
| film tackiness | 4 |
| adhesion | 4 |
| paper tearing | 3 |
| TOTAL | 18 |

As is seen in the table of the results, product 1 showed excellent properties as a glue when applied.

### Example 2: Preparation and Evaluation of the Blue Products 2, 3, 4 of the Invention

Following the procedure indicated in example 1 and using the same ingredients, the glue products 2-4 of the invention were prepared using the following amounts:

| | Product 2 | Product 3 | Product 4 |
|---|---|---|---|
| Ingredient | (grams) | (grams) | (grams) |
| Regalite R1090 | 20 | 10 | 0 |
| Regalite R1125 | 15 | 25 | 35 |
| Licocene PP1502 | 55 | 55 | 55 |
| Escorene Ultra | 10 | 10 | 10 |
| MV02528EH2 | | | |

Products 2-4 were evaluated for the same properties of product 1 under the same conditions and the following results were obtained.

| Test | Product 2 | Product 3 | Product 4 |
|---|---|---|---|
| Sliding | 3 | 3 | 3 |
| Transfer on | 4 | 4 | 4 |
| paper | | | |
| Film tackiness | 4 | 4 | 4 |
| Adhesion | 4 | 4 | 4 |
| Paper tearing | 3 | 3 | 3 |
| Total | 18 | 18 | 18 |

As seen from the table above, all the products of the invention, having different amounts of hydrogenated hydrocarbon resins, showed excellent properties as a glue, preferably suitable for use in stationery.

### Example 3: Preparation and Evaluation of the Glue Products of the Invention Obtained with Non-Hydrogenated Hydrocarbon Resins

Following the procedure indicated in example 1, the glue products 5-8 of the invention were prepared using the following amounts:

| ingredient | Product 5 (g) | Product 6 (g) | Product 7 (g) | Product 8 (g) |
|---|---|---|---|---|
| LICOCENE | 55 | 55 | 55 | 55 |
| PP1502 | | | | |
| ESCOREZ | 10 | 20 | 30 | 35 |
| 1502 | | | | |
| ARKON P125 | 25 | 15 | 5 | |
| ESCORENE | 10 | 10 | 10 | 10 |
| MV 02528 | | | | |

The products thus obtained were tested. The results obtained were good in terms of sliding, transfer, adhesion, tackiness and paper tearing. However, all the products obtained had a yellow color and had a strong odor.

### Comparative Example

In order to evaluate the criticality of the ingredients of the invention, some comparative examples are given hereinafter:

Following the procedure indicated in example 1 and using the same ingredients, the comparative glue products were prepared using the following amounts:

| | Comparative | Comparative | Comparative | Comparative |
|---|---|---|---|---|
| | product 1 | product 2 | product 3 | product 4 |
| Ingredient | (grams) | (grams) | (grams) | (grams) |
| Regalite R1090 | 38.6 | 47.1 | 55.7 | 30 |
| Regalite R1125 | 6.4 | 7.9 | 9.3 | 5 |
| Licocene | 45 | 35 | 25 | 45 |
| PP1502 | | | | |
| Escorene Ultra | 10 | 10 | 10 | 20 |
| MV02528 EH2 | | | | |

The comparative products 1-4 were evaluated for the same properties of product 1 under the same conditions and the following results were obtained.

| Test | Product 1 | Product 2 | Product 3 | Product 4 |
|---|---|---|---|---|
| Sliding | 2 | 2 | 3 | 2 |
| Transfer on | 1 | 1 | 1 | 1 |
| paper | | | | |
| Film tackiness | 2 | 1 | 1 | 1 |
| Adhesion | 2 | 1 | 1 | 1 |
| Paper tearing | 1 | 1 | 1 | 1 |
| Total | 8 | 6 | 7 | 6 |

As shown in the table above, the comparative products did not solve the problem of the invention. Moreover, the comparative product 1 was transferred too much and the comparative products 2 and 3 produced filaments and were also deformed to the touch. Product 4 which had an amount of 20% by weight of EVA was overly cohesive, so as to prevent the transfer of paper, and thereby the other properties.

1. An adhesive composition comprising:
at least one hydrocarbon resin in amount of at most 40% by weight with respect to the total weight of the composition;
at least one polyolefin derived from the polymerization of ethylene and/or propylene through metallocene catalysis and having a density in the range from 0.8 to 0.9 g/cm3; and
ethylene vinyl acetate (EVA) copolymer in an amount of at most 15% by weight with respect to the total weight of the composition.

2. The composition according to claim 1, wherein at least one hydrocarbon resin is hydrogenated, preferably transparent, commonly named as water white.

3. The composition according to claim 1, wherein the at least hydrocarbon resin is hydrogenated and has a softening point in the range from 80 to 130° C.

4. The composition according to claim 1, wherein at least one hydrocarbon resin is hydrogenated and is in an amount of at most 35% by weight with respect to the total weight of the composition.

5. The composition according to claim 1, wherein the at least hydrogenated hydrocarbon resin has a softening point in the range from 120 to 130° C. and is in an amount of at least 5% by weight with respect to the total weight of the composition.

6. The composition according to claim 1, wherein the composition comprises two hydrogenated hydrocarbon resins, of which at least one in an amount of 5% by weight with respect to the total weight of the composition and having a softening point in the range from 120 to 130° C.

7. The composition according to claim 1, wherein at least one polyolefin derived from the polymerization of ethylene and/or propylene through metallocene catalysis has a density in the range from 0.86 to 0.89 g/cm3.

8. The composition according to claim 1, wherein the EVA copolymer is in an amount from 10 to 15% by weight with respect to the total weight of the composition.

9. The composition according to claim 1, wherein the composition also comprises excipients selected from the group consisting of perfumes, dyes, pigments, glitter.

10. A glue product comprising the adhesive composition according to claim 1 and excipients suitable for the final formulation.

11. A process for the preparation of the glue product according to claim 10, comprising the steps of:
a) placing the adhesive composition according to claim 1 in a suitable container;
b) heating and mixing the composition at a temperature in the range from 125° C. to 220° C.;
c) pouring the product of step b) in a suitable mould of desired shape; and
d) cooling the product in the mould of the step c) to a temperature from −10° C. to 25° C.

12. The process according to claim 11, wherein between the step b) and the step c), the product of step b) is subjected to a degassing step, preferably under vacuum.

13. The process according to claim 11, wherein the suitable mould of desired shape of step c) is of silicone material or other non-stick material.

14. The process according to claim 11, wherein the step d) of cooling is carried out through water, optionally in the presence of antifreezing liquid, optionally also in the presence of a detaching additive, or through air with temperatures from −10° C. to 25° C. or still through nitrogen or other cryogenic gas.

15. The process according to claim 11, wherein the product of step d) is left to rest for at least one hour in the mould before removing it so as to obtain the product in a desired shape.

16. A ready-to-use glue product obtainable by the process according to claim 11.

17. A method for preparing a ready-to-use stationery adhesive product comprising the step of using the glue product according to claim 10.
